(19) United States
(12) Patent Application Publication
(10) Pub. No.: US 2015/0229075 A1
(43) Pub. Date: Aug. 13, 2015

(54) ELECTRICAL PLUG CONNECTOR

(71) Applicant: WIESON TECHNOLOGIES CO., LTD., New Taipei City (TW)

(72) Inventors: Chia-Yang LIN, New Taipei City (TW); Cheng-Rui ZHANG, New Taipei City (TW)

(21) Appl. No.: 14/320,026

(22) Filed: Jun. 30, 2014

(30) Foreign Application Priority Data
Feb. 7, 2014 (TW) 103202238

(51) Int. Cl. H01R 13/635; H01R 13/6582; H01R 13/627

(52) U.S. Cl. CPC H01R 13/635; H01R 13/6272; H01R 13/6582

(57) ABSTRACT

An electrical plug connector includes a connector body including a base member, a terminal holder, conducting terminals, a cable, a mount and a metal shield, a springy positioning member positioned in the mount and including a base plate, two hooks and a pressure plate, a slide shell slidably mounted around the connector body and having a front push-pull bar and compression springs set between the connector body and the slide shell. When moving the slide shell to disconnect the electrical plug connector from the connected mating electrical socket connector, the push-pull bar of the slide shell is moved over the pressure plate of the springy positioning member to disengage the hooks of the base plate from the respective hook holes of the metal shield of the mating electrical socket connector. Thus, the user can remove the electrical plug connector from the mating electrical socket connector with one single hand in one single operation step conveniently with less effort.

This application claims the priority benefit of Taiwan patent application number 103202238, filed on Feb. 7, 2014.

### BACKGROUND OF THE INVENTION

1. Field of the Invention

The present invention relates to electrical connector technology and more particularly, to an electrical plug connector, which allows the user to disconnect the electrical plug connector from the mating electrical socket connector with one single hand in one single operation step conveniently with less effort.

2. Description of the Related Art

Following fast development of modern electronics engineering technology, various advanced computers, notebooks, tablet computers, smart phones and many other advanced electronic sonic devices and systems have been well developed and widely used for different applications. Further, it is the market trend to create electronic devices having light, thin, short and small characteristics. In consequence, circuit board electronic components must be made extremely strong, small and precise.

Further, due to that the market trend of the design of computers and notebook goes toward miniaturization, the available installation space in a computer or notebook computer for electronic devices (hard disk drive, CD-ROM, etc.) is limited. In consequence, electronic components and electrical connectors for use in a computer mainboard must also be small-sized. In order to support large amount of electronic devices and to improve the transmission speed and system performance, advanced USB connectors, HDMI connectors, Display Port interfaces, and serial advanced technology attachment interface connectors (SATA, eSATA connectors) are developed. A SATA connector is adapted for use in a hard disk drive, CD-ROM or other internally mounted electronic device. An eSATA connector can be used in a detachable hard disk drive, CD-ROM, blue light CD drive or other detachable electronic device to replace a USB2.0 connector, However, an eSATA connector does not provide electric power. When using an eSATA connector in an external electronic device, an independent power supply device must be provided. In order to eliminate this problem, power eSATA connector is created. A power eSATA (eSATAp) connector is the combination of an eSATA connector and a USB connector.

FIG. 10 illustrates an electrical connector assembly consisting of an electrical plug connector B and an electrical socket connector A according to the prior art. As illustrated, the electrical socket connector A comprises a connector body A1 defining therein a mating connection chamber A0 and having a tongue plate A11 located at a front side thereof, a plurality of conducting terminals A2 mounted in the tongue plate A11 of the connector body A1, a first shell member A3 surrounding the connector body A1 and having a plurality springy retaining strips A31. When inserting the connector body B1 of the electrical plug connector B into the mating connection chamber A0 of the electrical socket connector A, the tongue plate A11 of the connector body A1 will be inserted into the insertion chamber B11 in the connector body B1 of the electrical plug connector B. After the two rails (not shown) at two opposite lateral sides of the connector body B1 of the electrical plug connector B are respectively set in the respective sliding grooves (not shown) at two opposite lateral sides of the tongue plate All of the connector body Al of the electrical socket connector A, the conducting terminals B2 of the electrical plug connector B are respectively abutted against the respective conducting terminals A2 of the electrical socket connector A, and at the same time, the springy retaining strips A31 of the first shell member A3 are respectively forced into engagement with respective retaining holes B3 in the second shell member B3 that surrounds the connector body B1 of the electrical plug connector B.

The electrical plug connector B and electrical socket connector A of the aforesaid prior art electrical connector assembly may be frequently connected and then disconnected. After a long use, the engagement between the springy retaining strips A31 of the first shell member A3 of the electrical socket connector A and the retaining holes B31 of the second shell member B3 of the electrical plug connector B can become unstable, and the electrical plug connector B can easily be pulled away from the electrical socket connector A to interrupt the connection if the cable (not shown) is stretched accidentally by an external force, leading to electrical connection failure or data loss. An improved design is known to provide springy retaining hooks (not shown) at the connector body B1 of the electrical plug connector B for engagement with respective hook holes in the first shell member A3 of the electrical socket connector A to enhance connection stability between the electrical plug connector B and the electrical socket connector A. However, the springy retaining hooks can be damaged easily after a long use. Further, when intending to disconnect the electrical plug connector B from the electrical socket connector A, the user needs to press the electrical plug connector B so as to disengage the springy retaining hooks from the respective hook holes in the first shell member A3 of the electrical socket connector A, complicating the operation. For long period application of an external electronic device, the factors of system stability and connector connection convenience must be taken into account. Therefore, the above-mentioned drawbacks of the prior art electrical connector designs must be improved.

### SUMMARY OF THE INVENTION

The present invention has been accomplished under the circumstances in view. It is therefore the main object of the present invention to provide an electrical plug connector, which facilitates connection to and disconnection from a mating electrical socket connector, assures a high level of connection stability and achieves the effects of low insertion force and high tensile strength.

To achieve this and other objects of the present invention, an electrical plug connector of the invention comprises a connector body, a springy positioning member, a slide shell slidably mounted around the connector body and the springy positioning member, and compression springs stopped between the connector body and the slide shell. The connector body comprises a base member, a terminal holder mounted in the front side of the base member, conducting terminals mounted in the terminal holder, a cable electrically connected with the conducting terminals, and a mount mounted in the top side of the terminal holder. The springy positioning member is positioned. In the mount of the connector body, comprising a base plate, two hooks obliquely backwardly extended from the top wall of the base plate and a pressure plate extended from the rear side of the base plate. The slide shell comprises a push-pull bar forwardly extended from the front side thereof. When moving the slide shell backwardly to disconnect the electrical plug connector from the connector body of the connected mating electrical socket connector, the compression springs are compressed, and the push-pull bar of the slide shell is pressed on the pressure plate of the springy positioning member to disengage the hooks of the base plate of the springy positioning member from the respective hook holes of the metal shield of the mating electrical socket connector. Thus, the user can remove the electrical plug connector from the mating electrical socket connector with one single hand in one single operation step conveniently with less effort.

Preferably, the mount comprises a mounting open chamber defined in the top side thereof for accommodating the springy positioning member, a beveled guide face located at the front side of the mounting open chamber, plurality of locating grooves located in the beveled guide face, a retaining block defined between each two adjacent locating grooves, a plurality of retaining hooks located in the mounting open chamber and respectively disposed adjacent to the locating grooves, and two stop blocks disposed at two opposite lateral sides near an opposing rear side of the mounting open chamber and partially suspending above the mounting open chamber.

Preferably, the springy positioning member further comprises a locating plate positioned in the mounting open chamber of the mount, a flexible space defined between the base plate and the locating plate, a plurality of arched connection portions connected between the base plate and the locating plate and respectively positioned in the locating grooves of the mount, a retaining groove defined in the front side of the base plate for engagement with the retaining block of the mount, two notches located in the base plate at two opposite lateral sides corresponding to the hooks, a plurality of hook holes located in the locating plate and respectively engagement with the retaining hooks of the mount, and two horizontal stop strips backwardly extended from the base plate and respectively stopped beneath the stop blocks within the mounting open chamber of the mount.

Preferably, the connector body further comprises a metal shield surrounding the bottom side of the terminal holder. The metal shield of the connector body comprises a pressure strip forwardly extended from the front side thereof and curved downwards and then upwards, and a plurality of locating holes respectively disposed near the front side thereof for connection with the metal shield of the mating electrical socket connector.

Other advantages and features of the present invention will be fully understood by reference to the following specification in conjunction with the accompanying drawings, in which like reference signs denote like components of structure.

### BRIEF DESCRIPTION OF THE DRAWINGS

FIG. 1 is an elevational view of an electrical plug connector in accordance with the present invention.

FIG. 2 is an exploded view of the electrical plug connector in accordance with the present invention.

FIG. 3 corresponds to FIG. 2 when viewed from another angle.

FIG. 4 is a sectional elevational view of the electrical plug connector in accordance with the present invention.

FIG. 5 is a schematic sectional side view of the present invention, illustrating the electrical plug connector inserted into a connector body of a mating electrical socket connector,

FIG. 6 corresponds to FIG. 5, illustrating the electrical plug connector and the mating electrical socket connector electrically connected.

FIG. 7 is a schematic sectional side view of the present invention, illustrating removal of the electrical plug connector from the mating electrical socket connector (I),

FIG. 8 is a schematic sectional side view of the present invention, illustrating removal of the electrical plug connector from the mating electrical socket connector (II).

FIG. 9 is a schematic sectional side view of the present invention, illustrating removal of the electrical plug connector from the mating electrical socket connector (III).

FIG. 10 is a sectional elevational view of an electrical plug connector according to the prior art.

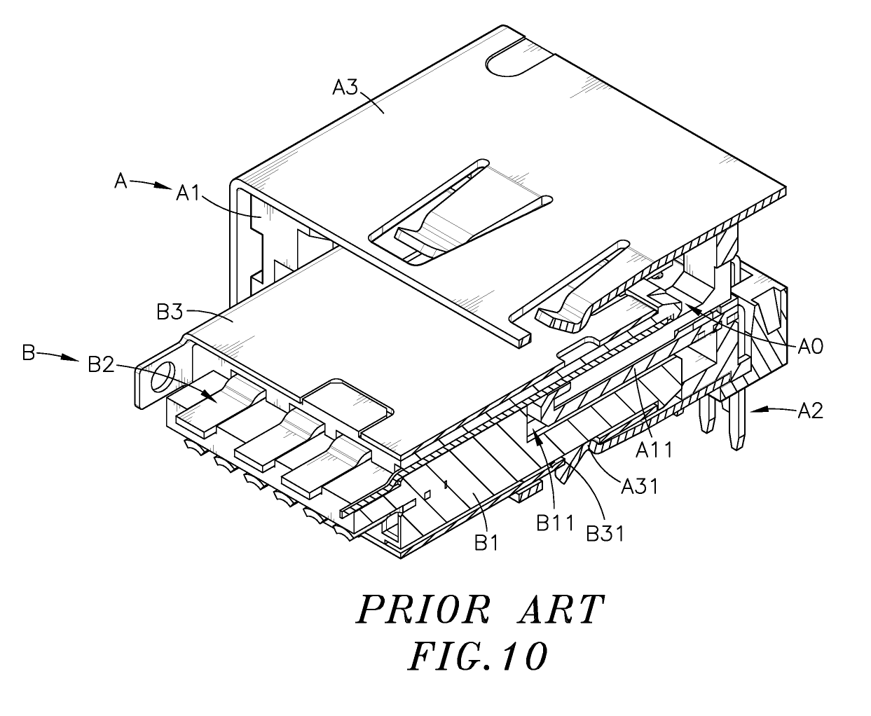

### DETAILED DESCRIPTION OF THE PREFERRED EMBODIMENT

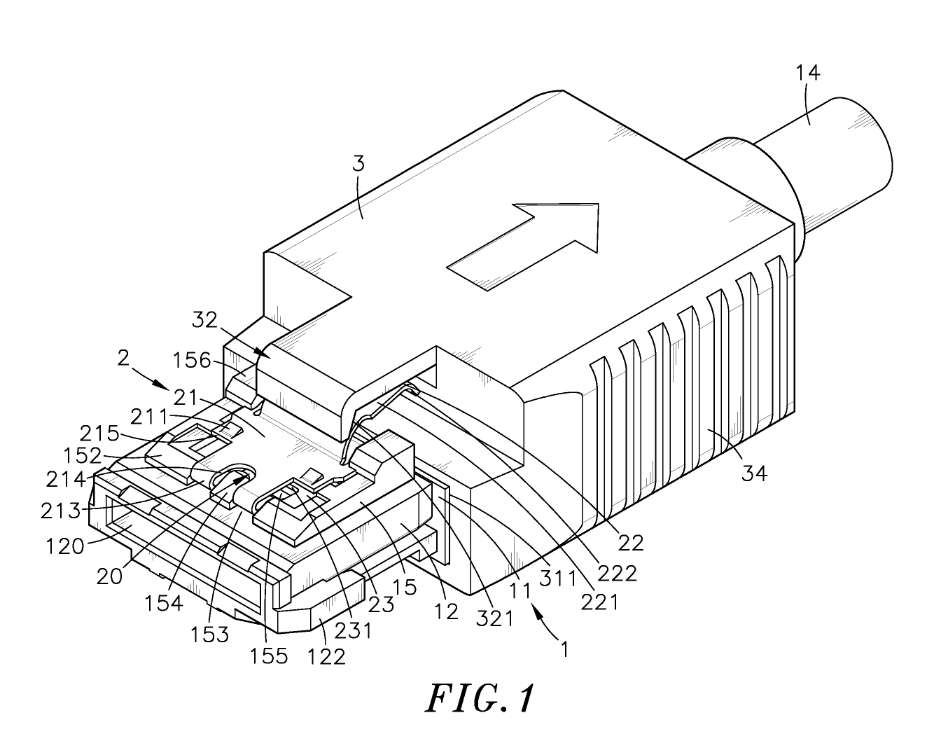

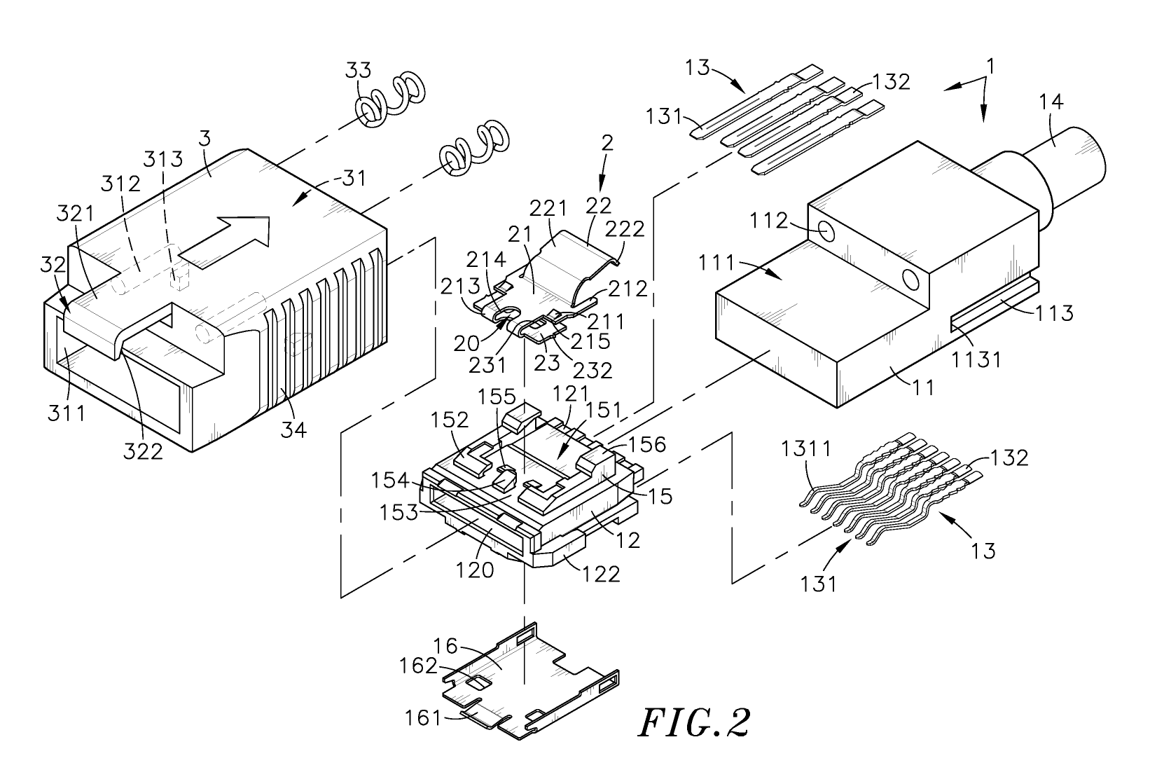

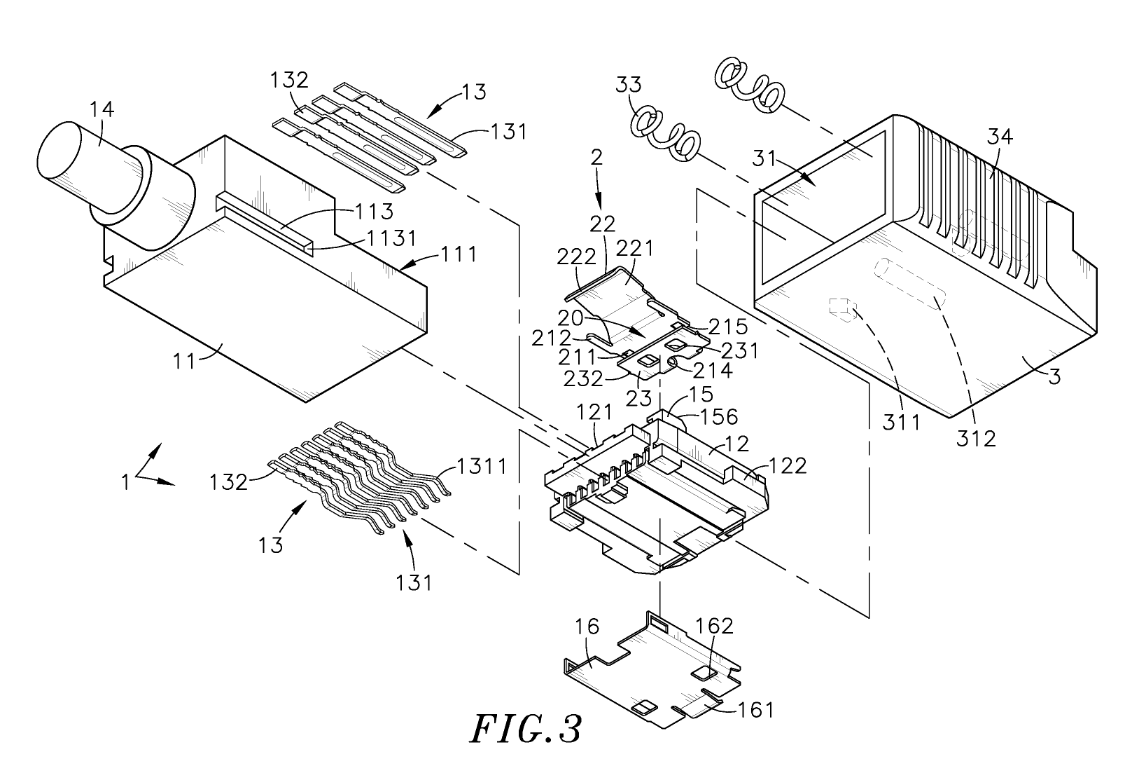

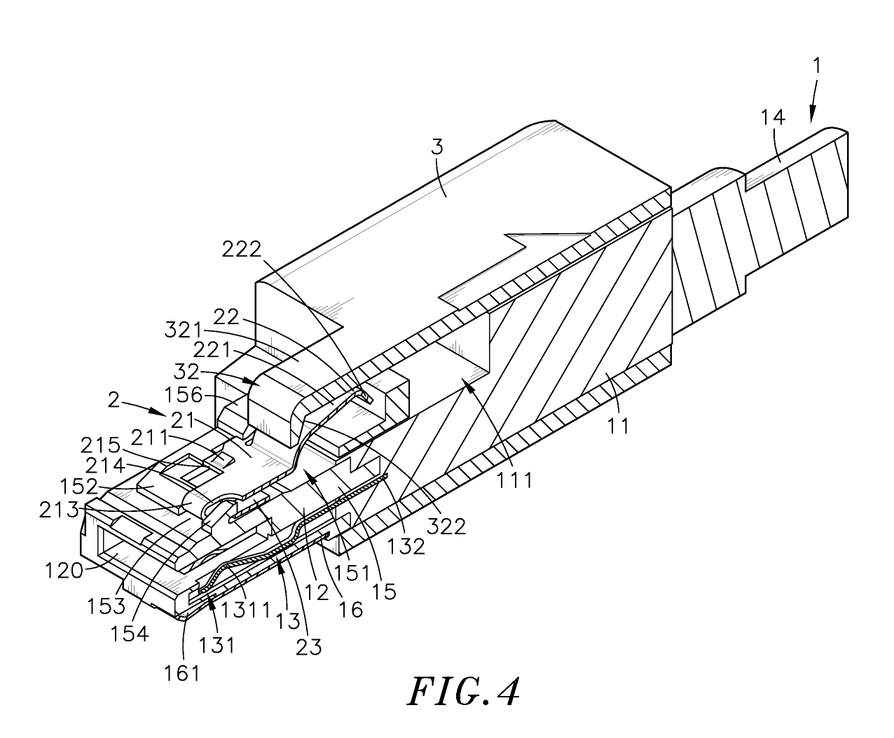

Referring to FIGS. 1-4, an electrical plug connector in accordance with the present invention is shown. The electrical plug connector comprises a connector body 1, a springy positioning member 2, and a slide shell 3.

The connector body 1 comprises a base member 11, a terminal holder 12, conducting terminals 13, a cable 14, a mount 15 and a metal shield 16. The base member 11 comprises at least one, for example, two locating holes 112 horizontally and bilaterally located in a front wall thereof in a parallel manner, a flat front extension block 111 forwardly extended from the front wall below the elevation of the locating holes 112, and two sliding grooves 113 symmetrically and horizontally located at two opposite sidewalk thereof and respectively defining a respective stop edge 1131 at an inner end thereof. The terminal holder 12 comprises an insertion slot 120, a plurality of terminal holes 121 located in opposing top and bottom walls thereof for accommodating the conducting terminals 13 respectively, and two guide rails 122 symmetrically disposed at two opposite lateral sides relative to the terminal holes 121. The conducting terminals 13 can be configured subject to USB2.0, USB3.0, eSATA, HDMI and/or Display Port standards, in the present preferred embodiment, the total amount of the conducting terminals 13 is 11, i.e., 4 pcs of the conducting terminals 13 are configured subject to USB2.0 standard, and the other 7 pcs of the conducting terminals 13 are configured subject to eSATA standard. The conducting terminals 13 are respectively mounted in the terminal holes 121 of the terminal holder 12, each comprising a front contact portion 131 located at a front end thereof and suspending in the insertion slot 120 of the terminal holder 12, a rear connection portion 132 located at an opposing rear end thereof for connection with a respective core wire (not shown) of the cable 14 by one of the techniques of bonding, clamping, insulation displacement connection and riveting, and a springy positioning arm 1311 connected between the front contact portion 131 and the rear connection portion 1132 and positioned in the insertion slot 120 of the terminal holder 12 to suspend the front contact portion 131 in the insertion slot 120. The cable 14 is electrically connected with the conducting terminals 13 and extended out of the rear wall of the base member 11. The mount 15 is mounted at the top wall of the terminal holder 12 above the terminal holes 121, comprising a mounting open chamber 151 defined in a top side thereof, a beveled guide face 152 located at a front side of the mounting open chamber 151, a plurality of, for example, two locating grooves 153 located in the beveled guide face 152, a retaining block 154 defined between the two locating grooves 153, a plurality of retaining hooks 155 located in the mounting open chamber 151 and respectively disposed adjacent to the locating grooves 153, and two stop blocks 156 disposed at two opposite lateral sides near an opposing rear side of the mounting open chamber 151 and partially suspending above the mounting open chamber 151. The metal shield 16 surrounds a bottom side of the bottom wall of the terminal holder 12, comprising a pressure strip 161 forwardly extended from a front side thereof and curved downwards and then upwards, and a plurality of locating holes 162 respectively disposed near the front side.

The springy positioning member 2 is a metal sheet member mounted in the mount 15, comprising a base plate 21, a plurality of, for example, two hooks 211 obliquely backwardly extended from a top wall of the base plate 21, a pressure plate 22 extended from a rear side of the base plate 21 and defining an obliquely backwardly extended front pushing surface 221 and a downwardly curved rear end portion 222, two horizontal stop strips 212 backwardly extended from the rear side of the base plate 21 and disposed at two opposite lateral sides relative to the pressure plate 212 and respectively stopped beneath the stop blocks 156 within the mounting open chamber 151 of the mount 15, a locating plate 23 positioned in the mounting open chamber 151 of the mount 15, a flexible space 20 defined between the base plate 21 and the locating plate 23, a plurality of, for example, two arched connection portions 213 connected between the base plate 21 and the locating plate 23 and positioned in the locating grooves 153, a retaining groove 214 defined in the front side of the base plate 21 for engagement with the retaining block 154 of the mount 15, two notches 215 located in the base plate 21 at two opposite lateral sides relative to the retaining groove 214 and corresponding to the hooks 211, a plurality of hook holes 231 located in the locating plate 23 and respectively forced into engagement with the retaining hooks 155 of the mount 15, and two protrusions 232 symmetrically located at two opposite lateral sides of the locating plate 23 and forced into friction engagement with the peripheral wall of the mounting open chamber 151 of the mount 15.

The slide shell 3 comprises an accommodation chamber 31 for accommodating the base member 11 of the connector body 1, a front opening 311 located in a front side thereof in communication with the accommodation chamber 31 for enabling the flat front extension block 111 of the base member 11 of the connector body to extend out of the front side of the slide shell 3, a push-pull bar 32 defining a horizontal suspension arm 321 that is forwardly extended from the front side of the slide shell 31 and a stop portion 322 that curves downwardly inwards from the distal end of the horizontal suspension arm 3211 remote from the front side of the slide shell 31 for stopping against the pressure plate 22 of the springy positioning member 2, at least one, for example, two locating rods 312 horizontally disposed in the accommodation chamber 31 and respectively movably inserted into the locating holes 112 of the base member 11 of the connector body 1, at least one, for example, two compression springs 33 respectively mounted on the locating rods 312 and stopped between an inside wall inside the accommodation chamber 31 of the slide shell 3 and an outside wall of the base member 11 of the connector body 1, two guide blocks 313 bilaterally disposed in the accommodation chamber 31 and respectively coupled to the sliding grooves 113 of the base member 11 of the connector body 1, and a grip 34 formed integral with two opposite sidewalls thereof.

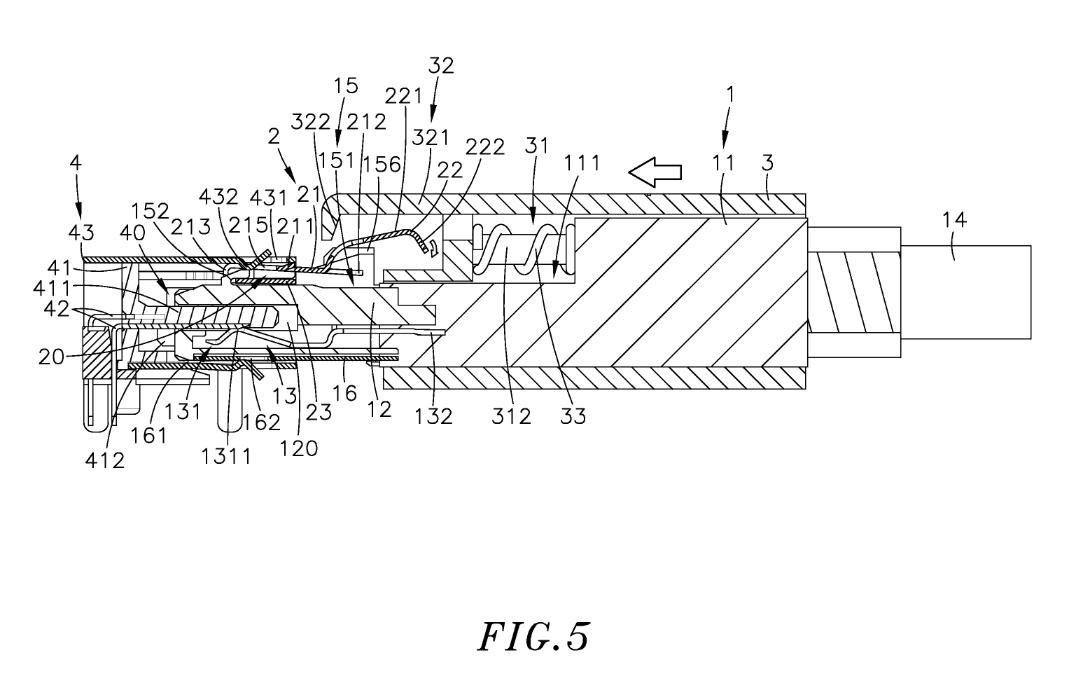

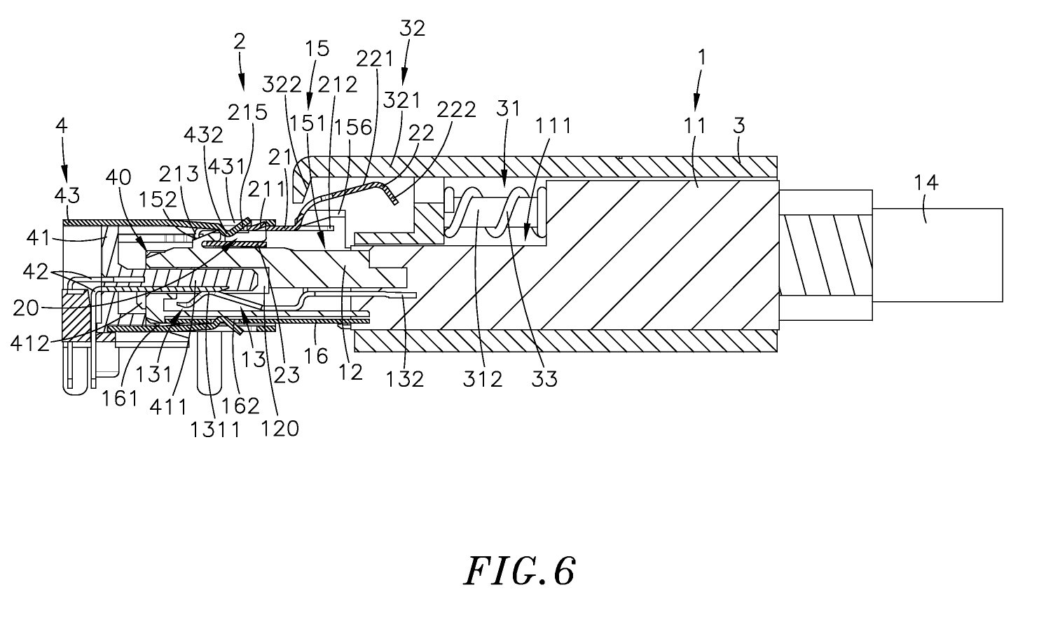

Referring to FIGS. 5 and 6, when in use, insert the terminal holder 12 of the connector body 1 into a mating connection chamber 40 in a connector body 41 of a mating electrical socket connector 4, and then hold the grip 34 to move the slide shell 3 toward the mating electrical socket connector 4 relative to the base member 11 to have the guide blocks 313 of the slide shell 3 be respectively stopped at the stop edges 1131 at respective inner ends of the sliding grooves 113, and then continuously move the slide shell 3 forward to carry the connector body 1 toward the mating electrical socket connector 4. At this time, the guide rails 122 of the terminal holder 12 are respectively forwardly moved along two opposite sliding grooves 412 in the mating connection chamber 40 of the connector body 41 of the mating electrical socket connector 4 to a connected position where a tongue plate 411 of the connector body 41 of the mating electrical socket connector 4 is inserted into the insertion slot 120 of the terminal holder 12 and the springy positioning arms 1311 and front contact portions 131 of the conducting terminals 13 are stopped abutted against respective conducting terminals 42 in the tongue plate 411 of the connector body 41 of the mating electrical socket connector 4.

Further, when inserting the terminal holder 12 of the connector body 1 into the mating connection chamber 40 of the connector body 41 of the mating electrical socket connector 4, the beveled guide face 152 of the mount 15 and the metal shield 16 are forced to push and deform springy retaining strips 432 of a metal shield 43 that surrounds the connector body 41 of the mating electrical socket connector 4, and the hooks 211 of the base plate 21 and the pressure plate 22 of the springy positioning member 2 are moved over the inside wall of the metal shield 43 and elastically deformed relative to the arched connection portions 213, enabling the hooks 211 and notches 215 of the base plate 21 of the springy positioning member 2 to be hooked in the respective hook holes 431 and respective springy retaining strips 432 of the metal shield 43 of the mating electrical socket connector 4, achieving the effects of low insertion force and high tensile strength. After connection, respective springy retaining strips 432 of the metal shield 43 of the mating electrical socket connector 4 are respectively engaged in the locating holes 162 of the metal shield 16 of the connector body 1 to enhance connection stability, avoiding displacement of the connector body 1 of the electrical plug connector relative to the mating connection chamber 40 of the connector body 41 of the mating electrical socket connector 4 when the cable 14 is stretched by an externally force and assuring a high level of signal transmission quality and reliability.

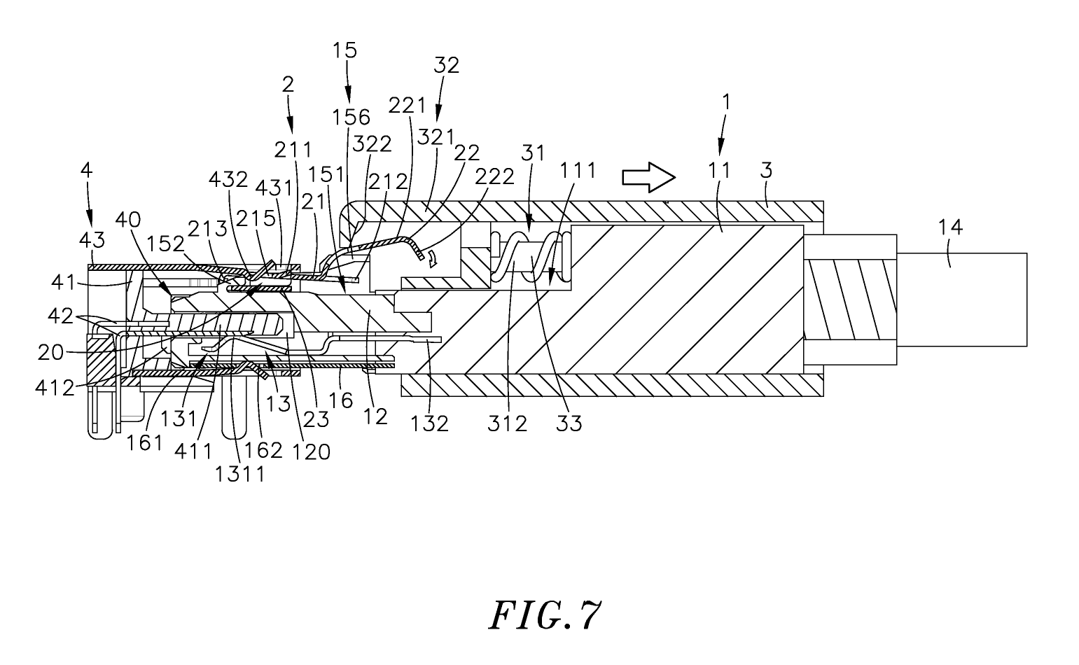

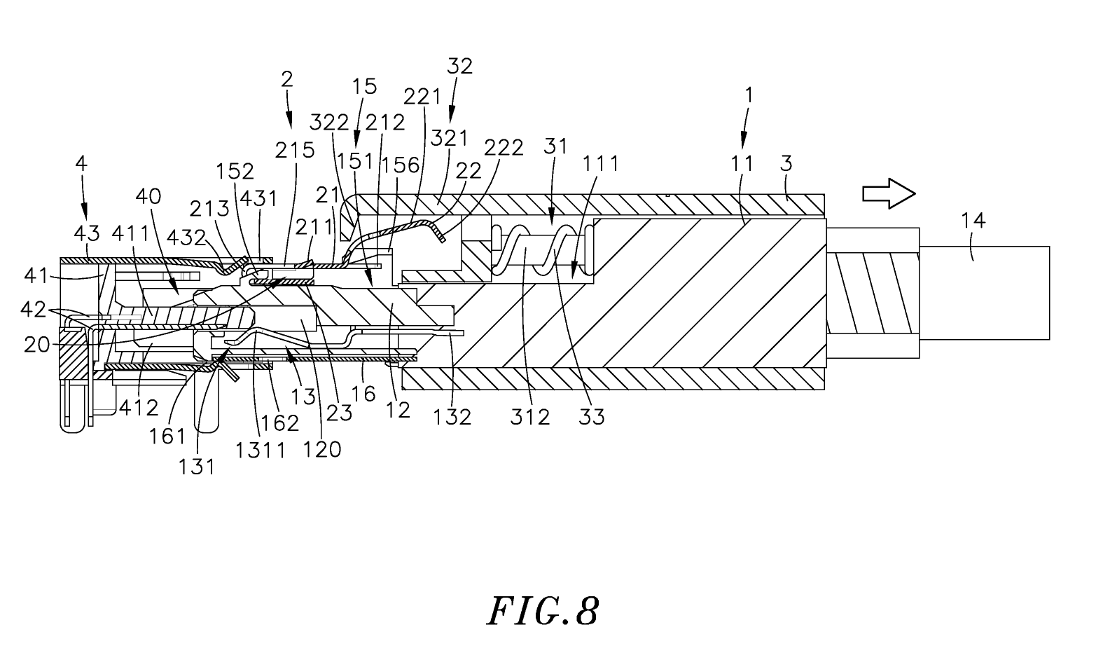

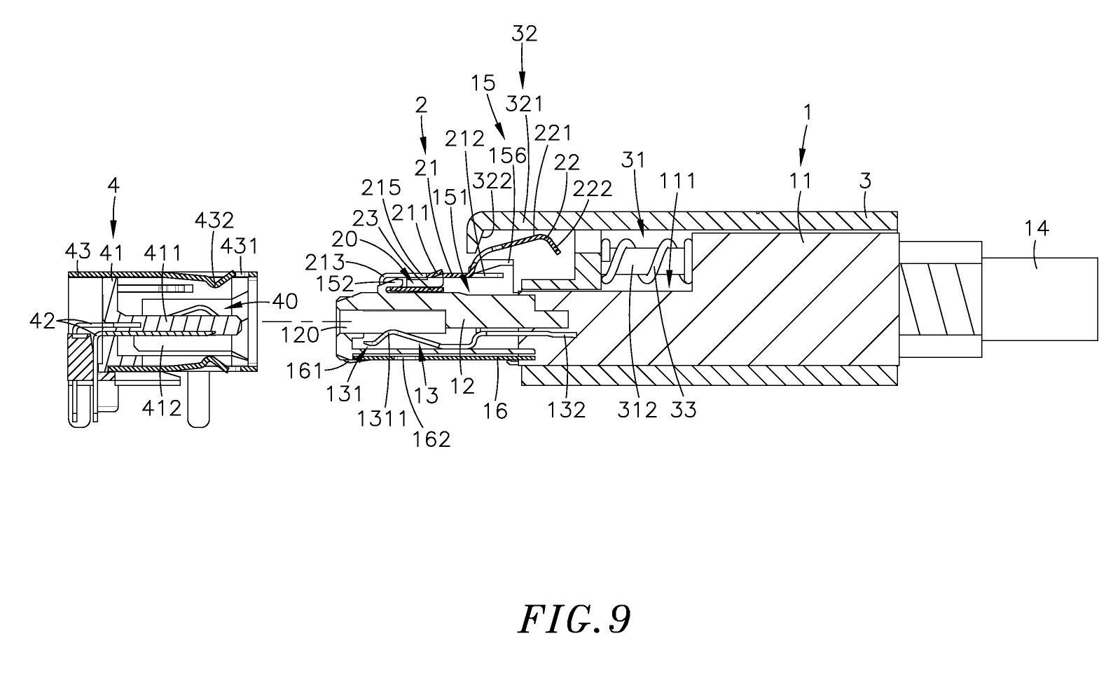

Referring to FIGS. 7-9, when intending to remove the electrical plug connector from the mating electrical socket connector 4, hold the grip 34 to move the slide shell 3 upward and then backward, moving the guide blocks 313 of the slide shell 3 along the sliding grooves 113 in direction away from the stop edges 1131 and to compress the compression springs 33. At this time, the compression springs 33 impart certain resistance against the backward movement of the slide shell 3, smoothening the sliding movement of the slide shell 3 relative to the connector body 1. This design can also avoid the sliding of the slide shell 3 when an external object accidentally impacts or touches the slide shell 3.

During backward displacement of the slide shell 3 relative to the connector body 1, the stop portion 322 of the push-pull bar 32 is moved over the obliquely backwardly extended front pushing surface 221 of the pressure plate 22 of the springy positioning member 2 to elastically deform the pressure plate 22, causing the hooks 211 and notches 215 of the base plate 21 of the springy positioning member 2 to be disengaged from the respective hook holes 431 and respective springy retaining strips 432 of the metal shield 43 of the mating electrical socket connector 4. At this time, the respective springy retaining strips 432 of the metal shield 43 of the mating electrical socket connector 4 are respectively disengaged from the locating holes 162 of the metal shield 16 of the connector body 1, enabling the connector body 1 of the electrical plug connector to be moved with the slide shell 3 out of the mating connection chamber 40 of the connector body 41 of the mating electrical socket connector 4. Because the direction of moving the slide shell 3 away from the mating electrical socket connector 4 is same as the direction of disengaging the hooks 211 of the base plate 21 of the springy positioning member 2 from the respective hook holes 431 of the metal shield 43 of the mating electrical socket connector 4, the user can remove the electrical plug connector from the mating electrical socket connector 4 with one single hand in one single operation step conveniently with less effort.

In conclusion, the invention provides an electrical plug connector, which comprises a connector body 1 that comprises a base member 11, a terminal holder 12 mounted in a front side of the base member 11, conducting terminals 13 mounted in the terminal holder 12, a cable 14 electrically connected with the conducting terminals 13, a mount 15 mounted in a top side of the terminal holder 12 and a metal shield 16 surrounding the terminal holder 12, a springy positioning member 2 that is positioned in the mount 15 of the connector body 1 and comprises a base plate 21, two hooks 211 obliquely backwardly extended from the top wall of the base plate 21 and a pressure plate 22 extended from the rear side of the base plate 21, a slide shell 3 that is slidably mounted around the connector body I and comprises a push-pull bar 32 forwardly extended from a front side thereof, and compression springs 33 set between the connector body 1 and the slide shell 3. When moving the slide shell 3 backwardly to disconnect the electrical plug connector from the connector body 41 of the connected mating electrical socket connector 4, the compression springs 33 are compressed, and the push-pull bar 32 of the slide shell 3 is pressed on the pressure plate 22 of the springy positioning member 2 to disengage the hooks 211 of the base plate 21 of the springy positioning member 2 from the respective hook holes 431 of the metal shield 43 of the mating electrical socket connector 4. Thus, the user can remove the electrical plug connector from the mating electrical socket connector 4 with one single hand in one single operation step conveniently with less effort,

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. An electrical plug connector detachably connected with a mating electrical socket connector, comprising:
a connector body comprising a base member, a terminal holder located at a front side of said base member for insertion into a mating connection chamber in a mating connector body of said mating electrical socket connector, a plurality of conducting terminals mounted in said terminal holder, each said conducting terminal comprising a front contact portion located at a front end thereof and suspending in said terminal holder and a rear connection portion located at an opposing rear end thereof, cable electrically connected with the rear connection portions of said conducting terminals and extending out of an opposing back side of said base member, and a mount mounted in a top side of said terminal holder;
a springy positioning member mounted in said mount, said springy positioning member comprising a base plate positioned in said mount, a plurality of hooks located at a top wall of said base plate for engaging in respective hook holes in a metal shield of said mating electrical socket connector, and a pressure plate extended from a rear side of the base plate; and
a slide shell slidably mounted around said connector body and said springy positioning member, said slide shell comprising an accommodation chamber for accommodating said base member of the connector body, a push-pull bar forwardly extended from the front side thereof and adapted for moving over said pressure plate to elastically deform said pressure plate and to cause disengagement of said hooks of said base plate of said springy positioning member from the respective hook holes of the metal shield of said mating electrical socket connector upon a backward movement of said slide shell relative to said mating electrical socket connector; and
a plurality of compression springs stopped between said connector body and said slide shell.

2. The electrical plug connector as claimed in claim 1, wherein said base member of said connector body comprises a plurality of locating holes horizontally and bilaterally located in a front wall thereof in a parallel manner, and a flat front extension block forwardly extended from the front wall below the elevation of said locating holes; said slide shell further comprises a front opening located in a front side thereof in communication with said accommodation chamber for enabling said flat front extension block of said connector body to extend out of the front side of said slide shell, and a plurality of locating rods horizontally disposed in said accommodation chamber and respectively movably inserted into said locating holes of said base member of said connector body;
said compression springs are respectively mounted around said locating rods of said slide shell and stopped between said connector body and said slide shell.

3. The electrical plug connector as claimed in claim 1, wherein said base member of said connector body further comprises two sliding grooves symmetrically and horizontally located at two opposite sidewalls thereof and respectively defining a respective stop edge at an inner end thereof; said slide shell further comprises two guide blocks bilaterally disposed in said accommodation chamber and respectively coupled to said sliding grooves of said base member of said connector body.

4. The electrical plug connector as claimed in claim 1, wherein said terminal holder comprises an insertion slot, a plurality of terminal holes located in opposing top and bottom walls thereof for accommodating said conducting terminals respectively, and two guide rails symmetrically disposed at two opposite lateral sides relative to said terminal holes.

5. The electrical plug connector as claimed in claim 1, wherein said mount comprises a mounting open chamber defined in a top side thereof for accommodating said springy positioning member, and a beveled guide face located at a front side of said mounting open chamber; said springy positioning member further comprises a locating plate positioned in said mounting open chamber of said mount, a flexible space defined between said base plate and said locating plate, a plurality of arched connection portions connected between said base plate and said locating plate.

6. The electrical plug connector as claimed in claim 5, wherein said hooks of said springy positioning member are obliquely backwardly extended from the top wall of said base plate.

7. The electrical plug connector as claimed in claim 5, wherein said mount further comprises a plurality of locating grooves located in said beveled guide face, a retaining block defined between each two adjacent said locating grooves, and a plurality of retaining hooks located in said mounting open chamber and respectively disposed adjacent to said locating grooves; said arched connection portions of said springy positioning member are respectively positioned in said locating grooves of said mount; said springy positioning member further comprises a retaining groove defined in the front side of said base plate for engagement with said retaining block of said mount, two notches located in said base plate at two opposite lateral sides corresponding to said hooks and a plurality of hook holes located in said locating plate and respectively engagement with said retaining hooks of said mount.

8. The electrical plug connector as claimed in claim 5, wherein said mount further comprises two stop blocks disposed at two opposite lateral sides near an opposing rear side of said mounting open chamber and partially suspending above said mounting open chamber; said springy positioning member further comprises two horizontal stop strips backwardly extended from said base plate and respectively stopped beneath said stop blocks within said mounting open chamber of said mount.

9. The electrical plug connector as claimed in claim 1, wherein said connector body further comprises a metal shield surrounding a bottom side of said terminal holder, said metal shield of said connector body comprising a pressure strip forwardly extended front a front side thereof and curved downwards and then upwards and a plurality of locating holes respectively disposed near the front side thereof for connection with the metal shield of said mating electrical socket connector.

10. The electrical plug connector as claimed in claim 1, wherein said push-pull bar of said slide shell comprises a forwardly extended horizontal suspension arm and terminating in a stop portion; said slide shell further comprises a grip formed integral with two opposite sidewalls thereof.
